(19) United States
(12) Patent Application Publication
(10) Pub. No.: US 2014/0139496 A1
(43) Pub. Date: May 22, 2014

(54) APPARATUS FOR INTERFACING WITH A TOUCH SCREEN DEVICE

(71) Applicant: HEX3 Limited, (US)

(72) Inventor: Jon Atherton, Queensland (AU)

(73) Assignee: HEX3 Limited, Wanchai (HK)

(21) Appl. No.: 13/868,378

(22) Filed: Apr. 23, 2013

Related U.S. Application Data
(60) Provisional application No. 61/719,038, filed on Oct. 26, 2012.
(60) Provisional application No. 61/637,094, filed on Apr. 23, 2012.

(51) Int. Cl. G06F 3/0354

(52) U.S. Cl. CPC G06F 3/03545
USPC 345/179

(57) ABSTRACT

Included are embodiments of an apparatus for interacting with a touch screen. The apparatus may include a pin that includes a first end and a second end, where the first end removably attaches to the instrument. The apparatus may also include a base assembly that is coupled to the second end of the pin. The base assembly may include a substrate layer, that is substantially transparent in appearance and a conductive layer that is substantially transparent in appearance and electrically interacts with conductive regions of the touch screen device and the substrate layer.

### CROSS REFERENCE

This application claims the benefit of U.S. Provisional Application No. 61/637,094, entitled Apparatus for Interfacing with a Touch Screen Device, filed Apr. 23, 2012, as well as U.S. Provisional Application No. 61/719,038 entitled Apparatus for Interfacing with a Touch Screen Device and filed Oct. 26, 2012, each of which is hereby incorporated by reference in their entireties.

### TECHNICAL FIELD

Embodiments disclosed herein are generally directed to an apparatus that may be used to interface with a touch screen device and, more specifically, to a conductive tip for interfacing with a touch screen device.

### BACKGROUND

Touch screen computing devices generally include a clear sensor panel and a display such as a liquid crystal display (LCD). A touch screen device may include an array of conductive regions positioned on a transparent substrate. When a user's finger or other instrument touches a specific location of the touch surface of the touch screen, the finger or other instrument may cause one or more of the conductive regions proximate the specific location to generate a signal. An approximate location of the finger or other instrument may be determined by analyzing the one or more signals from one or more of the conductive regions. In general, such analysis includes calculating a centroid based on the signals from the one or more conductive regions.

The resolution or spacing of the array of conductive regions is therefore directly related to the accuracy of determining where a user touched on the touch screen device. In many touch screen devices, the resolution of the array is high enough to approximate a location for a user's finger, which is relatively wide. However, other interface devices, such as a stylus with a narrow writing tip may be too narrow to cause proximate conductive regions to generate signals. Hence, when a user interfaces with the touch screen using a stylus or other such device with a small interface surface, the touch screen device may not approximate the location correctly.

To overcome the issues associated with interfacing with touch screen devices using a stylus or other such device, interface devices have been developed that include a larger interface surface such that the conductive regions of the array proximate a specific location interfaced by the user correctly generate a signal. For example, some conventional solutions include a stylus including a conductive disk configured to interface with the touch screen surface of the touch screen device, where the conductive disk is sized to interface with proximate conductive regions.

However, while such conventional systems address some shortcomings associated with using a stylus with a touch screen device, the conductive disks utilized in such styluses include solid conductive materials. Hence, a user utilizing such stylus generally cannot visually monitor with much accuracy the specific location that the conductive disk is interfacing. Furthermore, some conventional styluses include a pivotal connector (e.g., a ball for a ball joint) connecting the conductive disk to the stylus such that an angle may be maintained while interfacing with the touch screen surface. However, the pivotal connector implemented in conventional systems may cause issues when interfacing with the touch screen surface due to connection issues between the stylus body and the conductive disk, thereby preventing sufficient electrical interaction between the stylus and the array of conductive regions.

Therefore, a significant need continues to exist in the art for improved interface devices for touch screen computing devices.

### SUMMARY

Included are embodiments of an apparatus for interacting with a touch screen. The apparatus may include a pin that includes a first end and a second end, where the first end removably attaches to the instrument. The apparatus may also include a base assembly that is coupled to the second end of the pin. The base assembly may include a substrate layer that is substantially transparent in appearance and a conductive layer that is substantially transparent in appearance and electrically interacts with conductive regions of the touch screen device and the substrate layer.

Also included are embodiments of a stylus. The stylus may include a writing instrument and a tip. The writing instrument may include a receiving mechanism for receiving the tip and the tip may include a pin with a first end and a second end, where the first end removably attaches to the instrument. The writing instrument may additionally include a base assembly that is coupled to the second end of the pin. The base assembly may include a substrate layer that is substantially transparent in appearance and a conductive layer that is substantially transparent in appearance and electrically interacts with conductive regions of the touch screen device and the substrate layer.

These and other advantages and features disclosed herein, are set forth in the claims annexed hereto and forming a further part hereof. However, for a better understanding of the advantages and objectives described herein, reference should be made to the Drawings, and to the accompanying descriptive matter, in which there is described exemplary embodiments.

### BRIEF DESCRIPTION OF THE DRAWINGS

FIG. 1 depicts an apparatus that may be removably coupled to a stylus or other writing device for interfacing with a touch screen computing device;

FIG. 2 depicts the apparatus coupled to a stylus for use in interacting with a touch screen computing device, according to some embodiments described herein;

FIG. 3 depicts an apparatus that may be coupled to a stylus or other writing device for interfacing with a touch screen computing device, according to some embodiments described herein;

FIG. 4 depicts an apparatus that may be coupled to a stylus or other writing device for interfacing with a touch screen computing device, according to some embodiments described herein;

FIG. 5 depicts the apparatus coupled to a stylus for use in interfacing with a touch screen computing device, according to some embodiments described herein;

FIG. 6 depicts an apparatus that may be coupled to a stylus or other writing device for interfacing with a touch screen computing device, according to some embodiments described herein;

FIGS. 7A, 7B depict a plurality of views of a bi-spoke wheeled tip, according to some embodiments described herein;

FIGS. 8A, 8B depict a plurality of views of a base clamp bi-spoke wheeled tip, according to some embodiments described herein;

FIGS. 9A, 9B depict a plurality of views of a semi-rounded tip, according to some embodiments described herein;

FIGS. 10A, 10B depict a plurality of views of a tri-spoke wheeled tip, according to some embodiments described herein;

FIGS. 11A, 11B depict a plurality of views of a quad-spoke semi-rounded tip, according to some embodiments described herein;

FIGS. 12A, 12B depict a plurality of views of a hexagonal tip, according to some embodiments described herein;

FIG. 13 depicts a tip with a rectangular end, according to some embodiments described herein;

FIG. 14 depicts a coiled tip, according to some embodiments described herein;

FIGS. 15A, 15B depict another tip with a securing mechanism, according to some embodiments described herein;

FIGS. 16A, 16B depict a tip with a removable securing piece, according to some embodiments described herein;

FIGS. 17A, 17B depict a tip with a one piece base assembly and securing portion, according to some embodiments described herein;

FIGS. 18A, 18B depict another tip with a removable cover, according to some embodiments described herein;

FIGS. 19A, 19B depict another tip with a securing mechanism, according to some embodiments described herein; and

FIG. 20 depicts a tip with bi-spoke wheeled tip and a hinged securing mechanism, according to embodiments described herein.

It should be understood that the appended drawings are not necessarily to scale, presenting a somewhat simplified representation of various preferred features illustrative of the basic principles of embodiments described herein. The specific features consistent with embodiments disclosed herein, including, for example, specific dimensions, orientations, locations, sequences of operations and shapes of various illustrated components, will be determined in part by the particular intended application, use and/or environment. Certain features of the illustrated embodiments may have been enlarged or distorted relative to others to facilitate visualization and clear understanding.

### DETAILED DESCRIPTION

Embodiments described herein provide an apparatus that may be removably coupled to a stylus or other writing instrument for interacting with a touch surface of a touch-screen device. The apparatus includes an elongated pin configured to be gripped by the stylus or writing instrument. The elongate pin includes a notch proximate a first end, which may be gripped by a gripping mechanism of a stylus, and a pivotal connector that is proximate a second end. A base assembly includes a base aperture that may partially enclose the pivotal connector of the elongate pin to thereby form a ball joint which rotatably couples the disk assembly and the elongate pin. The disk assembly also includes a conductive layer that electrically interacts with conductive regions of a touch screen and a substrate layer. The conductive layer and the substrate layer may be substantially transparent such that a user may visually monitor the interaction between the writing instrument and the touch surface as compared to conventional systems that do not include transparent conductive layers and/or substrate layers. Additionally, some embodiments may include an attachment with a removable tip that may couple to a stylus. In other embodiments, the attachment may include a tip that is configured to be coupled to a conventional writing instrument (e.g., a mechanical pencil, an ink pen, and/or other such writing instrument).

Some embodiments include a substantially transparent conductive disk for interfacing with the touch surface of the touch screen device. In these embodiments, a user may visually monitor the specific location of interaction with the touch surface, while the substantially transparent conductive disk is configured to have a sufficient interaction surface to provide sufficient electrical interaction with proximate conductive regions. Further, some embodiments include a, pivotal connector, such as ball joint coupling between a first portion of the tip and a disk assembly including the conductive disk. These embodiments allow a user to maintain an angle with the stylus or writing instrument relative to the touch surface while interacting with the touch surface. In addition, such ball joint may include conductive paste to thereby provide better conductivity between the pin and the disk assembly.

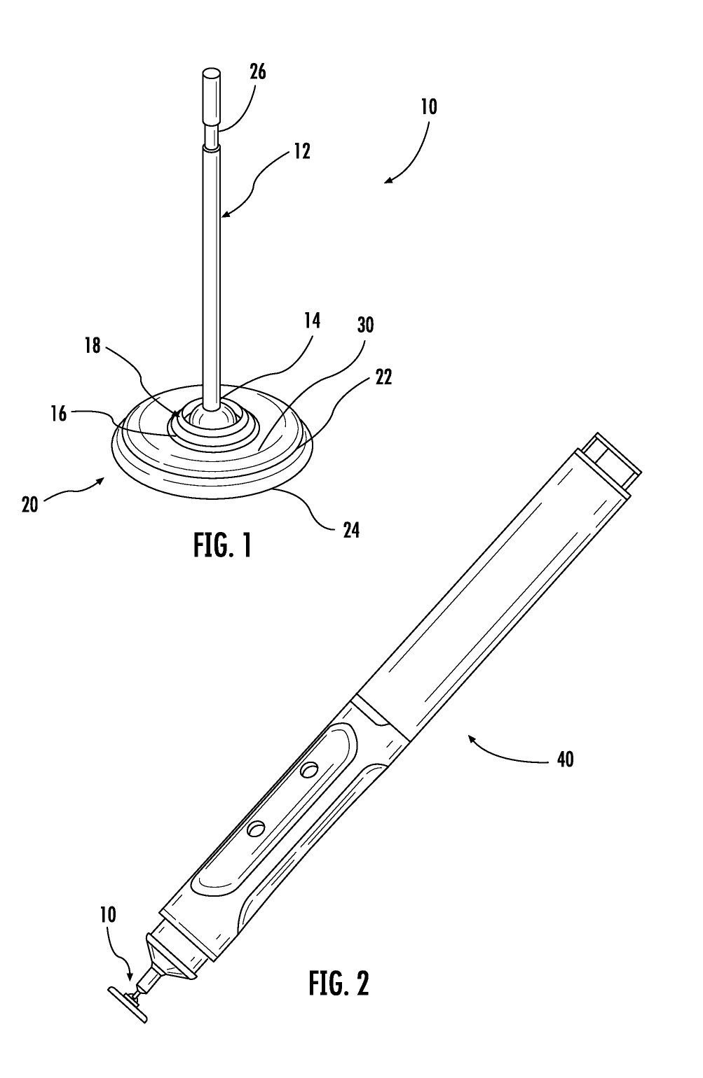

Referring now to the drawings, FIG. 1 depicts a tip 10, which may be configured as a removable attachment, according to embodiments disclosed herein. The tip 10 includes a pin 12 that may be gripped by a stylus or writing instrument. The pin 12 may include a pivotal connector 14 at a first end, where the pivotal connector 14 may be positioned in a base aperture 16 (such as a cup) thereby forming a ball joint 18. Depending on the embodiment, the pin 12 may be plated with a conductive material to further increase conductivity.

The base aperture 16 includes a part of a base assembly 20, where the base assembly 20 includes the base aperture 16, a conductive layer 22, a substrate 24, and an upper surface 30. In some embodiments, the conductive layer 22 includes a substantially transparent conductive material, such as a conductive mesh, including for example 3M® unpatterned transparent conductor (UTC) film, or other such substantially transparent conductive materials such as EmiClare indium tin oxide (ITO) film. The substrate 24 may also include a substantially transparent material, including for example materials including polyethylene terephthalate (PET). In some embodiments, the conductive layer 22 may be patterned on the substrate 24, including for example by depositing conductive material and etching the conductive material to form a pattern. Further, the pin 12 may include a notch 26, where notch 26 may be configured to be gripped by a stylus or other writing instrument.

The pin 12 may be of any suitable dimension to interface with a writing instrument, but in some embodiments is about 18 centimeters long. Similarly, the notch 26 may be constructed with any suitable dimensions, but in some embodiments is about 1.5 centimeters long, with a diameter that is about 0.05 centimeters less than the diameter of the remaining portions of the pin 12. The pivotal connector 14 may also have any suitable dimensions, but may include a radius of about 0.95 centimeters. The substrate 24 may also be of any suitable dimensions, but in some embodiments may have a radius of about 8 centimeters and a thickness that may range between about 0.10 centimeters to about 0.15 centimeters.

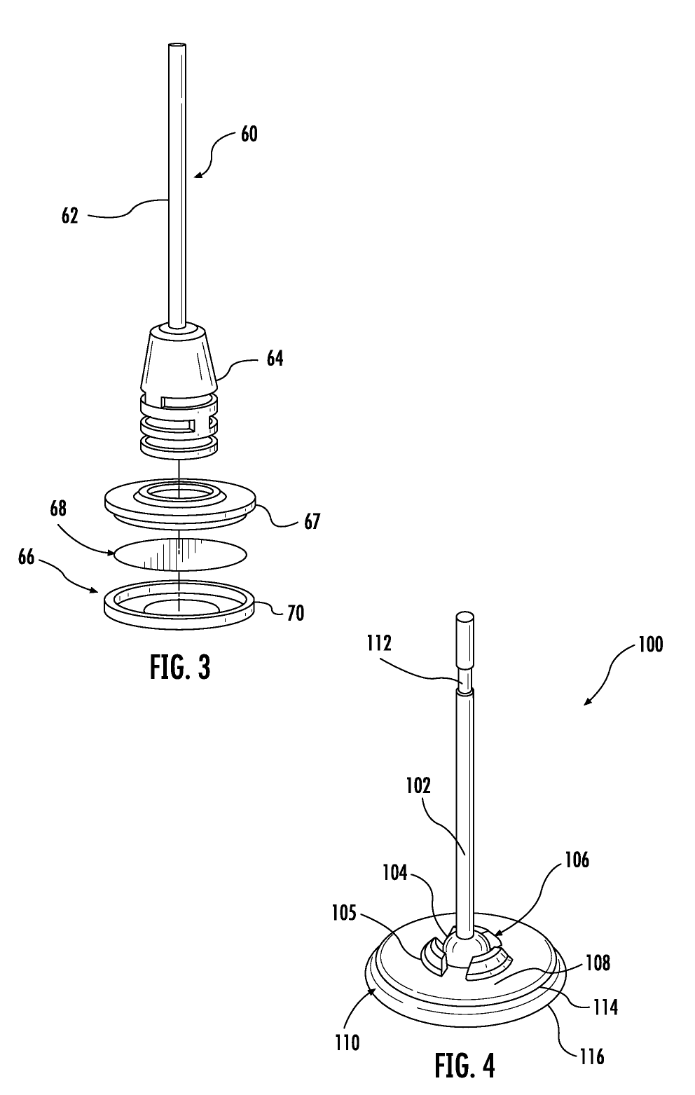

FIG. 2 depicts a tip 10 according to one embodiment coupled to a stylus 40. While a stylus 40 is shown in FIG. 2, a tip 10 may be coupled to other writing instruments, including for example a mechanical pencil. The stylus 40 may include a receiving mechanism that receives and secures the tip 10 (permanently or removably). As an example, the tip 10 may be sized such that the stylus 40 receives the pin as pencil lead would normally be received. The mechanical pencil may enclose and grip the tip 10 similarly. For example, some mechanical pencils may receive and grip 0.7 inch lead, and the pin 12 may be sized similarly such that the mechanical pencil may receive and grip the pin 12.

FIG. 3 depicts a tip 60 consistent with some embodiments described herein. The tip 60 includes a pin 62 that may be gripped by a stylus and/or other writing instrument to thereby couple the tip 60 to the stylus or other writing instrument. The pin 62 is coupled to a boot 64, and the boot 64 is removably coupled to a base assembly 66. The boot 64 may be removably coupleable with a disk top 67 of the base assembly 66, where the disk top 67 may include a conductive material and/or a substantially transparent material. The disk top 67 is connected to a conductive layer 68 of the disk assembly, where the conductive layer 68 may include a conductive material and the conductive layer 68 may be substantially transparent. The base assembly 66 further includes a base layer 70 that may be substantially transparent. The conductive layer 68 in this exemplary embodiment may include a substantially transparent conductive material, such as a conductive mesh between two layers of a base component over-molded with silicon.

As described with other embodiments herein, the pin 62 may include a pivotal assembly for coupling to the base assembly 66. The pivotal assembly may be configured as a ball, or other piece (e.g., cylindrical, circular, rectangular, etc.) that is received by a base aperture in the base assembly 66. This coupling allows flexibility between the pin 62 and the base assembly 66, thereby allowing the base assembly 66 to substantially or fully contact the touch screen when in use.

FIG. 4 depicts a tip 100 according to embodiments described herein. Tip 100 includes a pin 102 that may be coupled to a stylus or similar instrument consistent. Consistent with other embodiments herein, the pin 102 may include a conductive material, including for example stainless steel, carbonized steel, aluminum, nickel, and/or any other such conductive materials and/or combinations thereof. A pivotal connector 104 is attached to the pin 102 proximate a first end of the pin 102, and the pivotal connector 104 is positioned in a base aperture 105 to thereby form a ball joint 106. The base aperture 105 is attached to a disk top 108, where the disk top 108 is a component of a base assembly 110. In this particular embodiment, the pin 102 includes a notch 112 proximate a second end, where the notch 112 is configured to be gripped by a stylus and/or other similar instrument for coupling therewith.

It should be understood that the base aperture 105 may include one or more portions positioned in a substantially circular manner such that a pivotal connector of a pin may be placed within the base aperture 105 to thereby form a ball-joint. Similarly, the base assembly 110 includes a disk top 108 including a base aperture 105, a conductive layer 114 connected to the disk top 108 and a substrate/base layer 116 connected to the conductive layer 114.

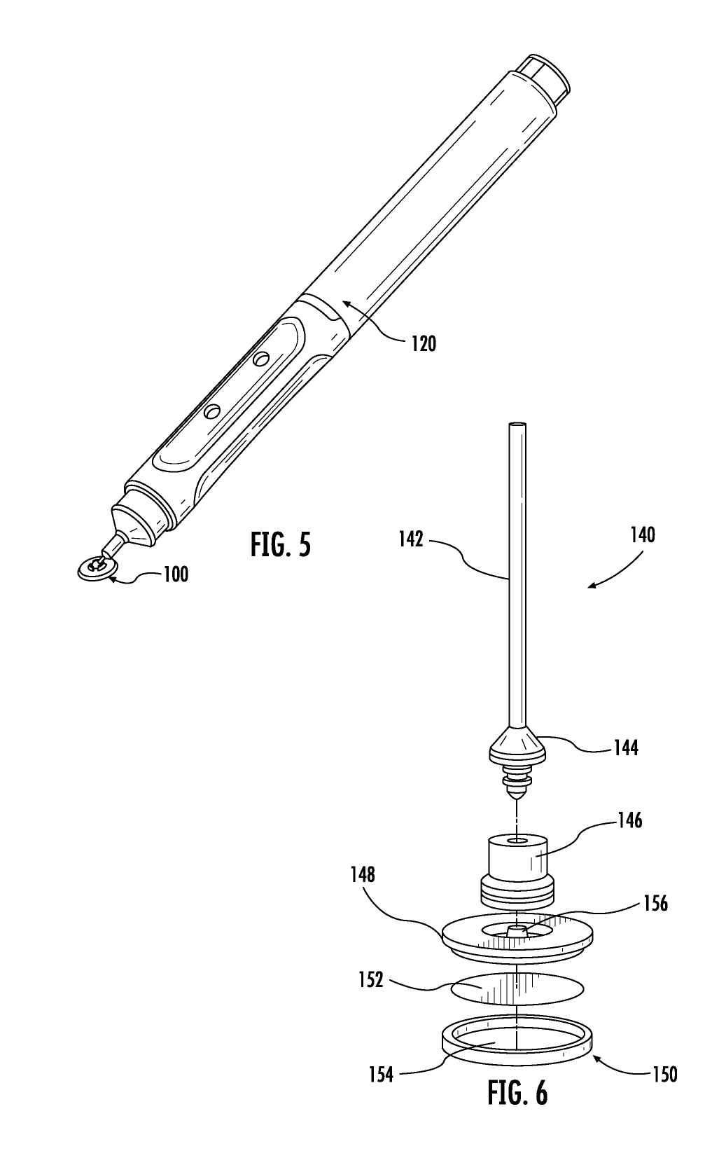

FIG. 5 depicts the tip 100 of FIG. 4 removably coupled to a stylus 120. Specifically, because the tip 100 is configured as described above, the stylus 120 may be positioned at extremely small angles and still maintain connection with the touch screen.

FIG. 6 depicts an exploded view of a tip 140 according to embodiments described herein. As illustrated, the tip 140 includes a pin 142 having a connector 144 attached to a first end. The connector 144 is coupled to a second connector 146, where the second connector may include a boot. The second connector 146 is coupled to a disk top 148 of a base assembly 150. The connector 144 and the boot of the second connector 146 may pivotally couple the pin 142 and the base assembly 150. The base assembly 150 may include the disk top 148, a conductive layer 152 and a base layer 154. The conductive layer 152 may be substantially transparent, and may include a conductive mesh.

For example and consistent with other embodiments herein, the conductive layer 152 may include a composite material, including for example, a carbon fiber material such as the carbon fiber mat manufactured and sold as Cytec Thornel® Mat VMA Carbon Fiber. The disk top 148, includes a notched recess 156 configured to couple to the boot of the second connector 146. The disk top may include a substantially transparent and/or conductive material, including for example a conductive polycarbonate based material. Similarly, the base layer 154 may include a substantially transparent and/or conductive material, including for example a conductive material including polycarbonate material.

As described with other embodiments herein, the pin 142 may include a pivotal assembly for coupling to the base assembly 150. The pivotal assembly may be configured as a ball, or other piece (e.g., cylindrical, circular, rectangular, etc.) that is received by a base aperture in the base assembly 150. This coupling allows flexibility between the pin 142 and the base assembly 150, thereby allowing the base assembly 150 to substantially or fully contact the touch screen when in use.

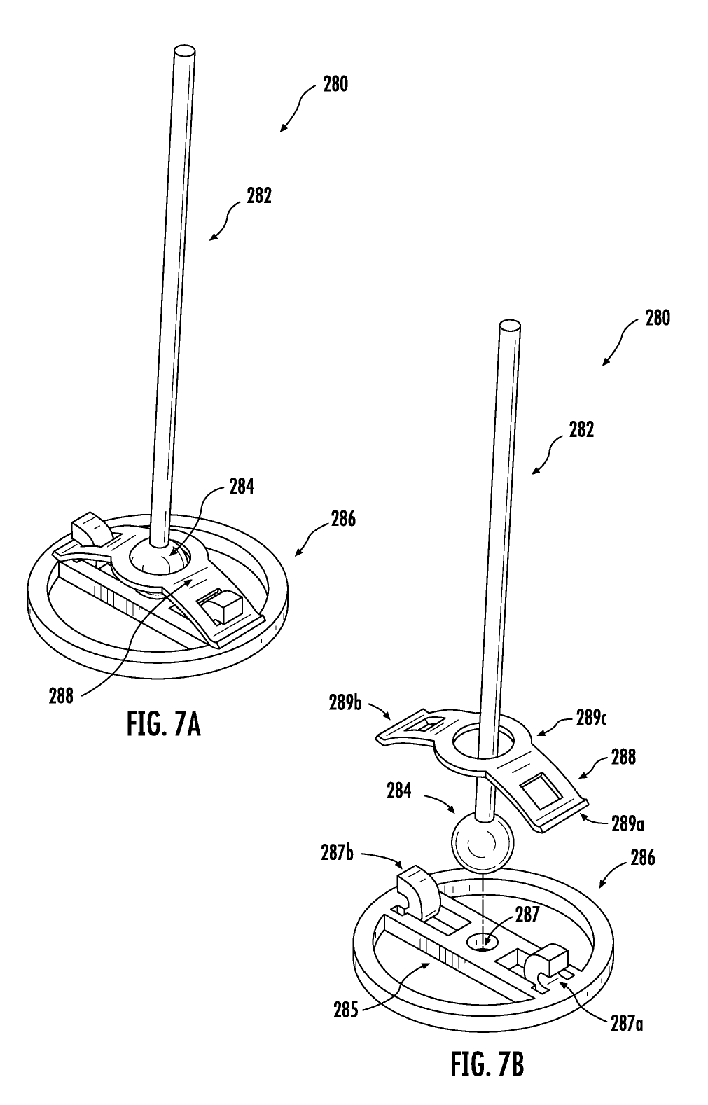

FIGS. 7A, 7B depict a plurality of views of a bi-spoke wheeled tip 280, according to some embodiments described herein. As illustrated, the bi-spoke wheeled tip 280 includes a pin 282 coupled to a pivotal connector 284. The pivotal connector 284 is coupled to a base assembly 286, which contacts the touch screen, as described with regard to other embodiments, above. The base assembly 286 may be structured as a rounded, circular, oval, or other similarly shaped assembly and may include a center piece 285 that substantially bisects the base assembly 286. As discussed above, the base assembly 286 may include a substrate, a conductive layer, conductive paste and/or other components. The center piece 285 may include base aperture 287 and a plurality of attachment structures 287a, 287b, positioned toward a perimeter of the base assembly 286. The base aperture 287 may be positioned toward the center of the base assembly 286 and the center piece 285 and sized to receive and removably secure the pivotal connector 284.

Also included is a securing mechanism 288 that is configured as a removable cover and includes a plurality of cover apertures 289a, 289b, and 289c. Specifically, the cover aperture 289c may receive the pin 282, such that that when the pivotal connector 284 is positioned on the base aperture 287, the securing mechanism 288 may be placed on the pivotal connector 284 and base assembly 286 to removably secure the pivotal connector 284 on the base aperture 287. The cover apertures 289a, 289b may engage with attachment structures 287a, 287b to further facilitate the coupling. As illustrated, the securing mechanism 288 may be removed by depressing the attachment structures 287a, 287b toward the center of the base assembly 286 and forcing the securing mechanism 288 away from the base assembly 286. As illustrated, the embodiment of FIGS. 7A, 7B allow for a base assembly 286 to be secured, while allowing the pin 282 and the pivotal connector 284 to rotate within the base aperture 287. As such, the base assembly 286 can fully contact the touch screen, even if the pin 282 is directed at a predetermined angle from the touch screen.

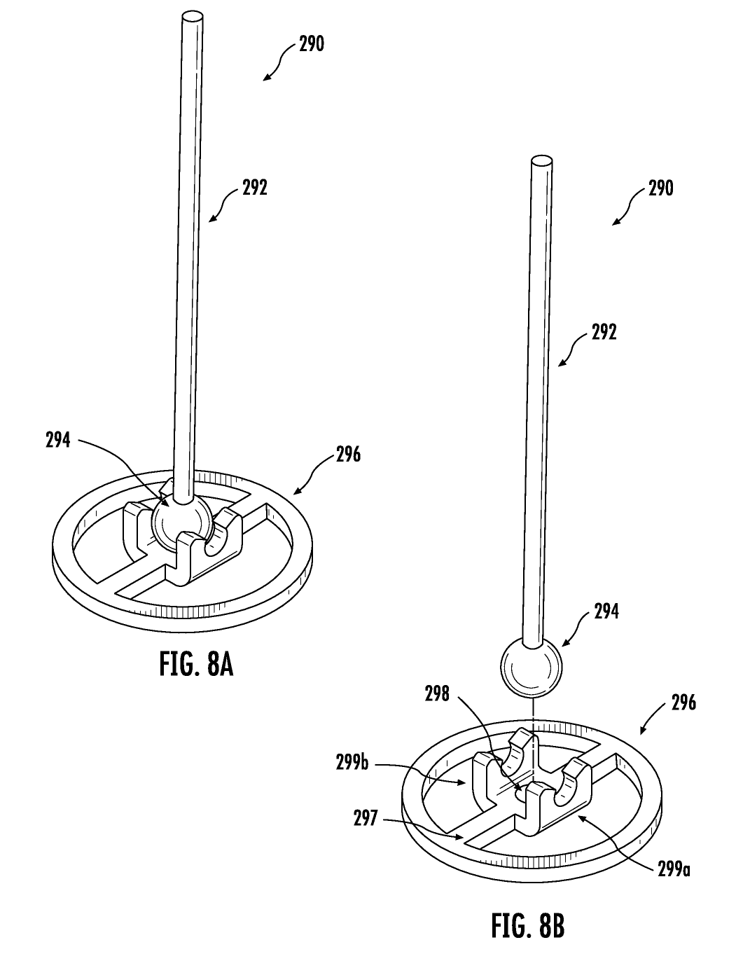

FIGS. 8A, 8B depict a plurality of views of a base clamp bi-spoke wheeled tip 290, according to some embodiments described herein. As illustrated, the base clamp bi-spoke wheeled tip 290 includes a pin 292 and a pivotal connector 294, as described in other embodiments. Also included is a base assembly 296, which may be approximately circular, oval, or otherwise in a rounded configuration. As discussed above, the base assembly 296 may include a substrate, a conductive layer, conductive paste and/or other components. Also included is a center piece 297, which substantially bisects the base assembly 296. On the center piece 297 is a base aperture 298 for receiving the pivotal connector 294, as well as a securing mechanism that is defined by base attachment portions 299a, 299b. The base attachment portions 299a, 299b may be configured to removably secure the pivotal connector 294, through frictional contact with the pivotal connector 294. As described above with regard to FIGS. 7A, 7B, the base clamp bi-spoke wheeled tip 290 in this embodiment may rotate to provide a more ergonomic apparatus, to fully contact the touch screen.

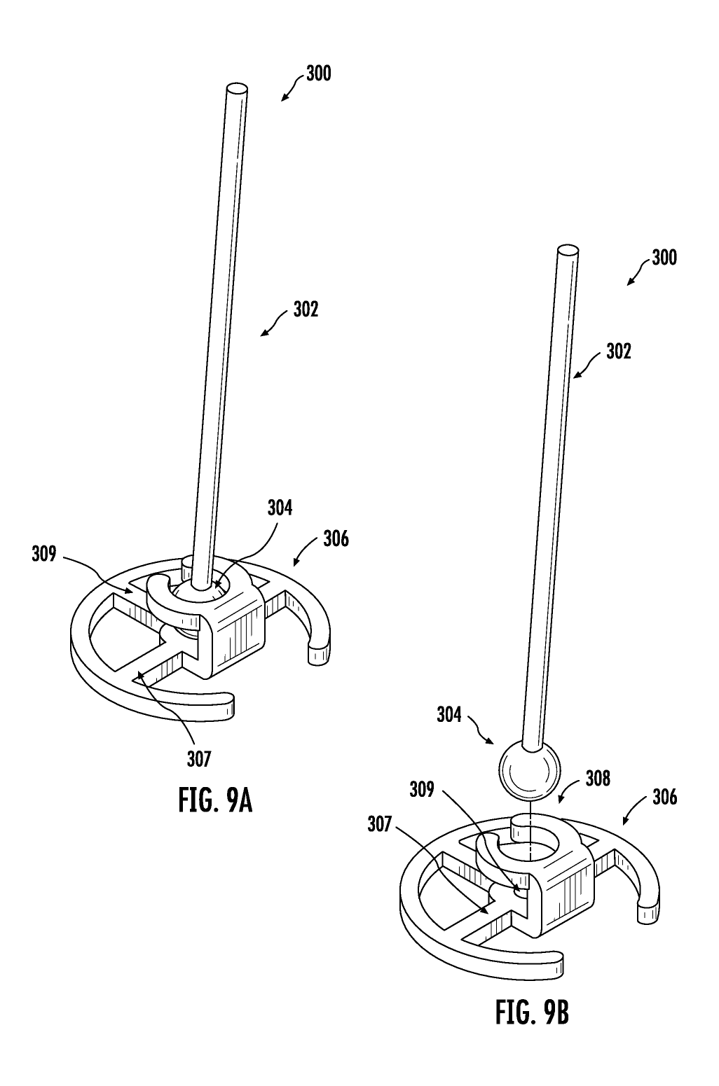

FIGS. 9A, 9B depict a plurality of views of a semi-rounded tip 300, according to some embodiments described herein. As illustrated, the semi-rounded tip 300 includes a pin 302 and a pivotal connector 304. Also included is a base assembly 306, which is configured with an open rounded (or “C-shape”) footprint. The base assembly 306 may include a center piece 307, which includes three portions that extend to the perimeter of the base assembly 306. As discussed above, the base assembly 306 may include a substrate, a conductive layer, conductive paste and/or other components. In the center of the center piece 307 is a base aperture 309 (only depicted in FIG. 9B), which receives and removably secures the pivotal connector 304. The base assembly 306 also includes a securing mechanism 308, which may be constructed of a flexible material for further securing the pivotal connector 304. Specifically, the securing mechanism 308 may be flexible to allow insertion of the pivotal connector 304 between the securing mechanism 308 and the base aperture 309. However, the securing mechanism 308 may be sized, such that when the pivotal connector 304 is inserted, the securing portion restricts movement of the pivotal connector 304 from the base aperture 309. As with the other embodiments, however, the pivotal connector 304 may rotate when coupled to the base assembly 306.

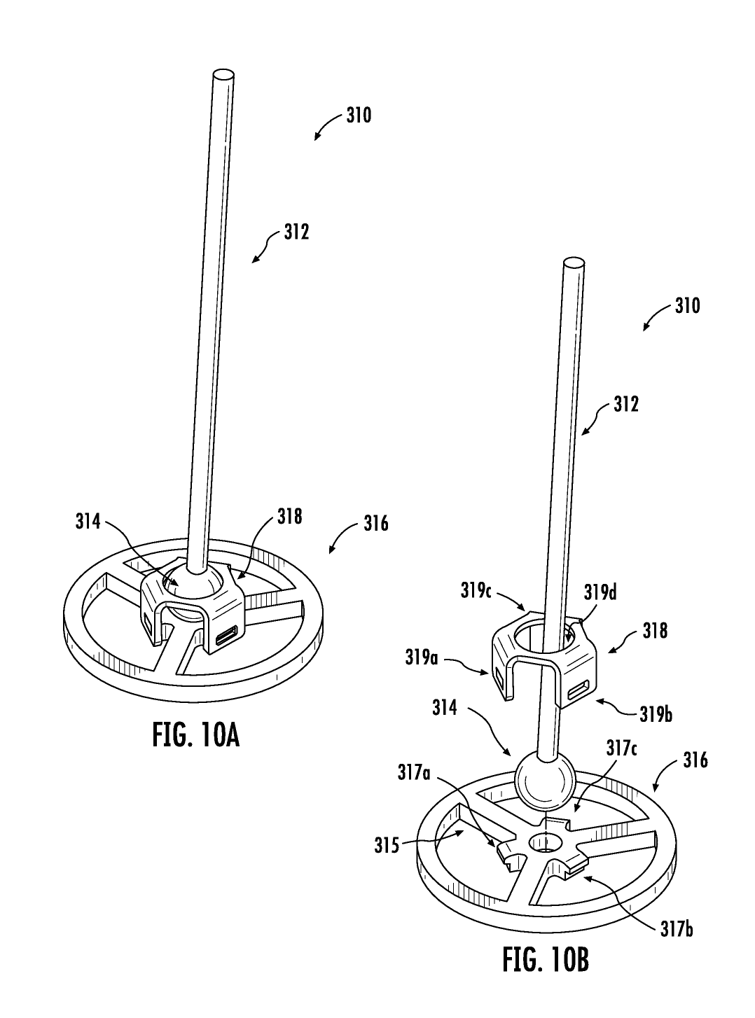

FIGS. 10A, 10B depict a plurality of views of a tri-spoke wheeled tip 310, according to some embodiments described herein. As illustrated, the tri-spoke wheeled tip 310 includes a pin 312, a pivotal connector 314, and a base assembly 316. As discussed above, the base assembly 316 may include a substrate, a conductive layer, conductive paste and/or other components. However, in this embodiment, the base assembly 316 may be rounded, such as a circular or oval shaped component, and may have a center portion with three extension pieces that extend to the perimeter of the base assembly 316. Also part of the base assembly 316 is a base aperture 315, which receives the pivotal connector 314. The base assembly 316 also includes a plurality of securing pieces 317a, 317b, 317c positioned between the extension pieces. The securing pieces 317a, 317b, 317c engage with the securing mechanism 318, or other removable cover. Specifically, the securing mechanism 318 includes a plurality of flanges, each with a cover aperture 319a, 319b, 319c, as well as a center aperture 319d. The pin 312 may be inserted into the center aperture 319d and the securing mechanism 318 may be coupled to the base assembly 316 by engaging the cover apertures 319a, 319b, 319c with the securing pieces 317a, 317b, 317c, respectively. By doing so, the securing mechanism 318 may removably secure the pivotal connector 314 and pin 312 to the base assembly 316. Additionally, the center aperture 319 may be sized such that rotation of the pivotal connector 314, and thus movement of the pin 312 may be achieved.

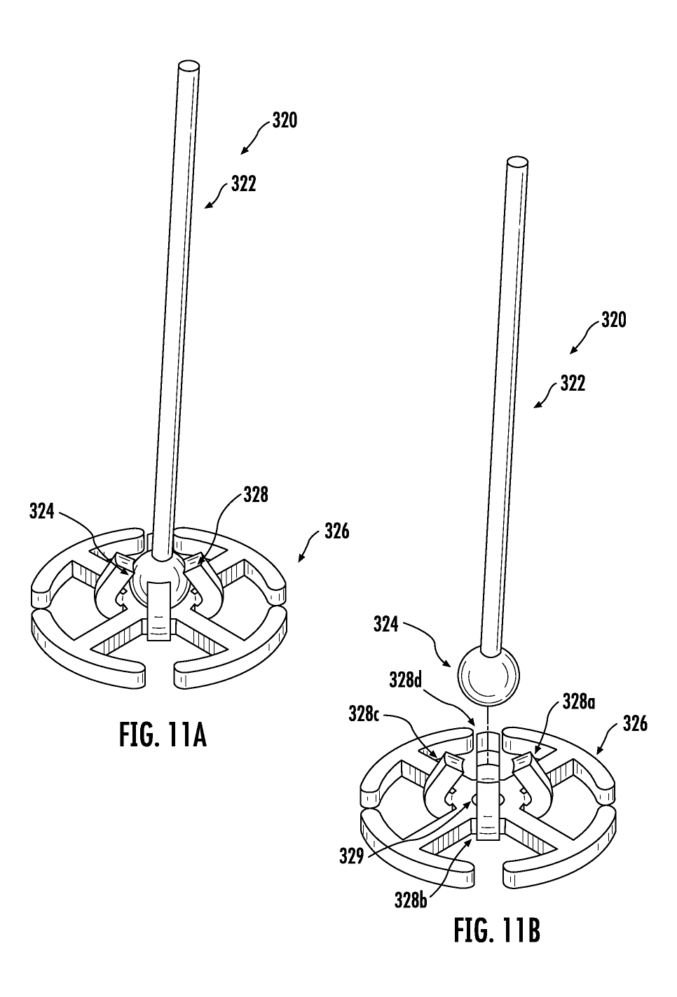

FIGS. 11A, 11B depict a plurality of views of a quad-spoke semi-rounded tip 320, according to some embodiments described herein. As illustrated, the quad-spoke semi-rounded tip 320 may include a pin 322, a pivotal connector 324, and a base assembly 326. As discussed above, the base assembly 326 may include a substrate, a conductive layer, conductive paste and/or other components. However, the base assembly 326 in this embodiment may be constructed with a center portion and four extending pieces (collectively 328), which each for part of an unconnected rounded perimeter. Also included in the base assembly 326 is a securing mechanism includes at least one flexible member that is defined by four securing pieces 328a, 238b, 328c, 328d, and a base aperture 329 for receiving and securing the pivotal connector 324. Specifically, the securing pieces 328a, 328b, 328c, 328d may be constructed of a flexible material and may be positioned to create a perimeter that allows the pivotal connector 324 to be placed adjacent to the base aperture 329, but rigid enough to removably secure the pivotal connector 324 in that position. Again, when the pivotal connector 324 is inserted adjacent to the base aperture 329, the securing pieces 328a, 328b, 328c, 328d allow rotation of the pivotal connector 324.

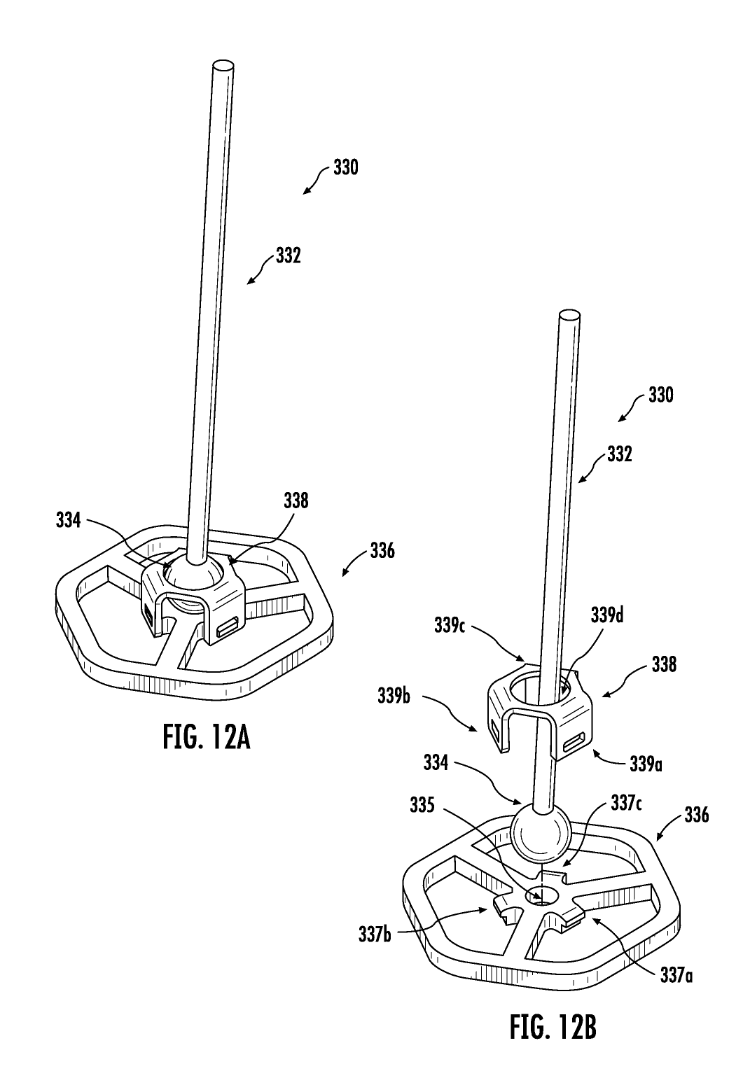

FIGS. 12A, 12B depict a plurality of views of a hexagonal tip 330, according to some embodiments described herein. As illustrated, the hexagonal tip 330 may include a pin 332, a pivotal connector 334, and a base assembly 336. As discussed above, the base assembly 336 may include a substrate, a conductive layer, conductive paste and/or other components. The base assembly 336 may include a securing mechanism 338, with three pieces extending to a hexagonal perimeter. Also included are a base aperture 335 for receiving the pivotal connector 334 and a plurality of securing pieces 337a, 337b, 337c for receiving a securing mechanism 338 or other removable cover, as depicted with regard to FIGS. 10A, 10B, the securing mechanism 338 may include a plurality of extensions with respective apertures 339a, 339b, 339c. The apertures 339a, 339b, 339c engage with the securing pieces 337a, 337b, and 337c for securing the pivotal connector 334 adjacent to the base aperture 335. A center aperture 339d may be configured to receive the pin 332 and may be sized to allow rotation of the pivotal connector 334 and thus allow movement of the pin 332.

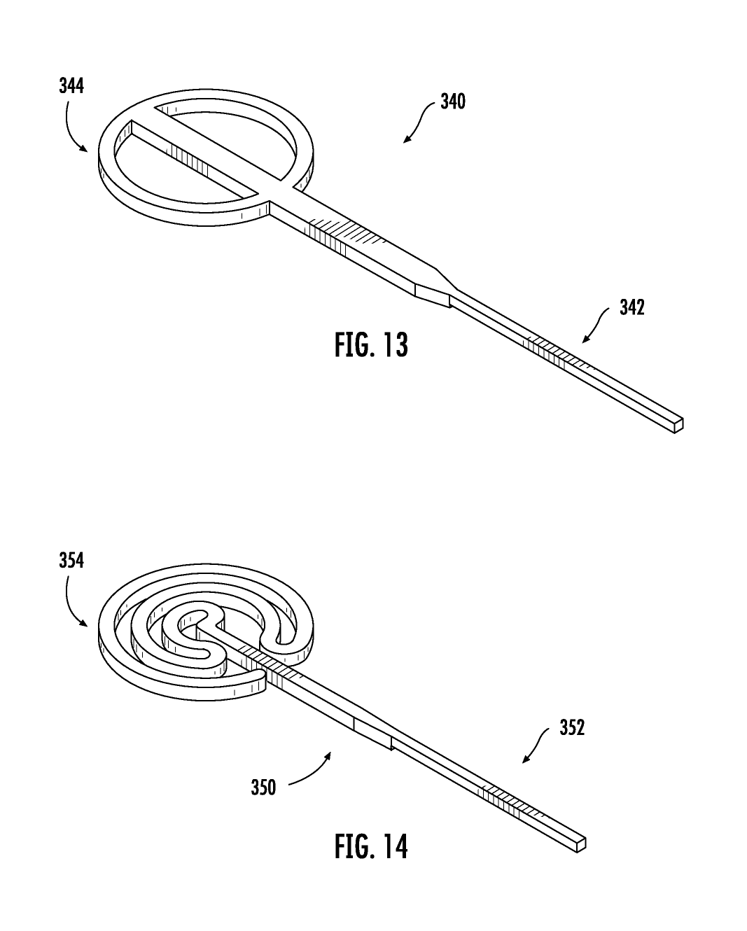

FIG. 13 depicts a tip 340 with a rectangular pin 342, according to some embodiments described herein. As illustrated, the tip 340 includes the rectangular pin 342, which may be utilized for insertion into a stylus, such as the stylus 40 from FIG. 3. Additionally, the tip 340 includes a rounded base assembly 344 for contacting the touch screen. As discussed above, the rounded base assembly 344 may include a substrate, a conductive layer, conductive paste and/or other components.

FIG. 14 depicts a coiled tip 350, according to some embodiments described herein. As illustrated, the coiled tip 350 includes a rectangular pin 352, as well as coiled base assembly 354. As discussed above, the coiled base assembly 354 may include a substrate, a conductive layer, conductive paste and/or other components. Specifically, the coiled base assembly 354 may be configured such that the user may pull out the coil, which forms a spring. The spring may then be used to interact with the touch screen. In some embodiments, the user may pull the coil out to form a spring for interacting with the touch screen. This may include bending the coiled base assembly 354 such that the primary plane of the coiled base assembly 354 is substantially perpendicular to the primary plane of the rectangular pin 352.

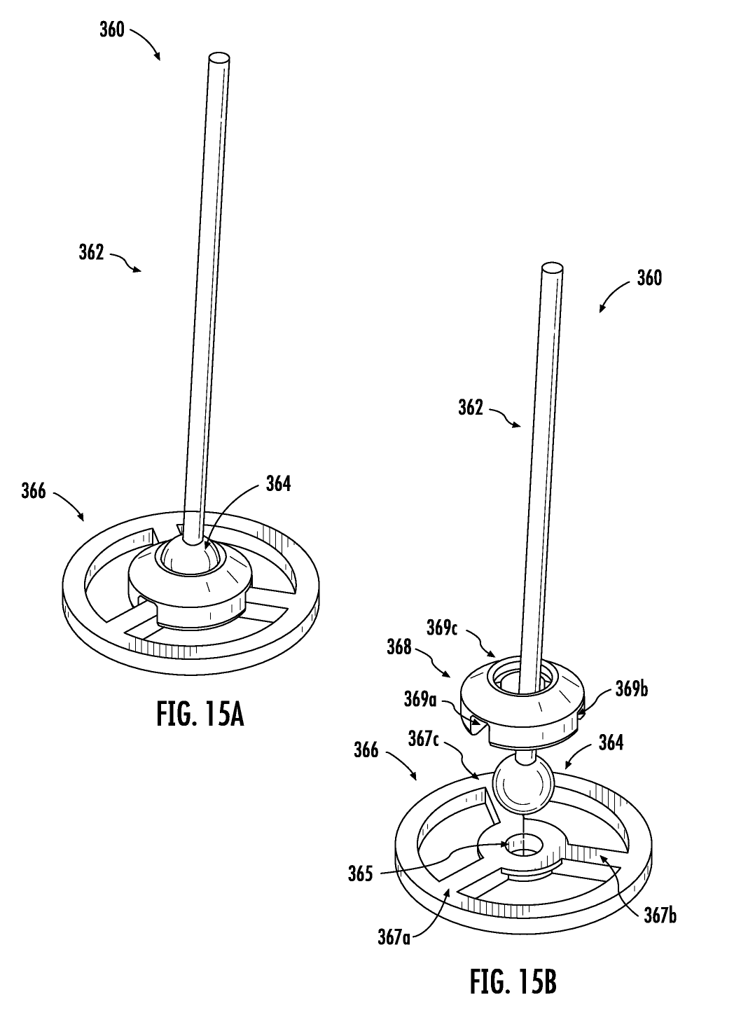

FIGS. 15A, 15B depict another tip 360 with a securing mechanism 368 or other removable cover, according to some embodiments described herein. As illustrated, the tip 360 includes a pin 362, a pivotal connector 364, and a base assembly 366. As discussed above, the base assembly 366 may include a substrate, a conductive layer, conductive paste and/or other components. The base assembly 366 may additionally include three extension pieces 367a, 367b, 367c, which extend from a center portion with a base aperture 365. The base aperture may receive and removably secure the pivotal connector. Additionally, the securing mechanism 368 may include a plurality of cover apertures 369a, 369b, 369c, which are received by the extension pieces 367a, 367b, 367c for removably securing with the base assembly 366.

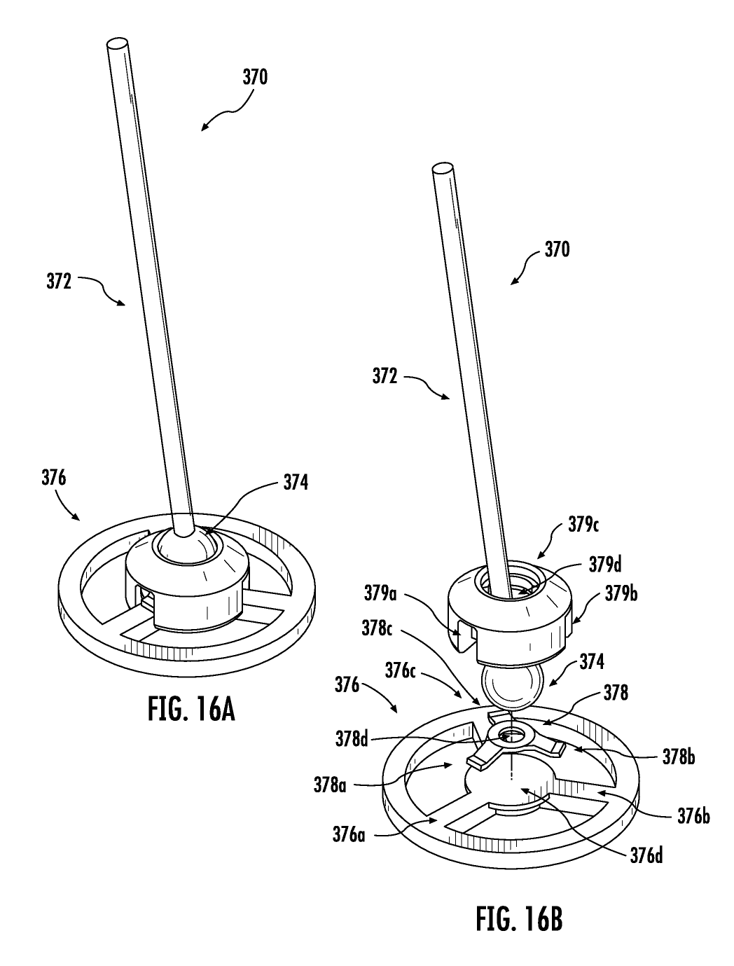

FIGS. 16A, 16B depict a tip 370 with a removable securing piece 378, according to some embodiments described herein. As illustrated, the tip 370 also includes a pin 372, a pivotal connector 374, and a base assembly 376. As discussed above, the base assembly 376 may include a substrate, a conductive layer, conductive paste and/or other components. The base assembly 376 may additionally include three extension pieces 376a, 376b, 376c. Also included is the removable securing piece 378, which has three securing extension pieces 378a, 378b, 378c, which align with the extension pieces 376a, 376b, 376c. The removable securing piece 378 may couple to a removable securing piece 378d that includes a center aperture 379d for receiving and removably securing the pivotal connector 374. Also included is a securing mechanism that includes plurality of cover apertures 379a, 379b, 379c for engaging with the extension pieces 376a, 376b, 376c, thereby securing the pivotal connector 374. The center aperture 379d receives the pin 372, which allows for rotation of the pivotal connector 374 and movement of the pin 372.

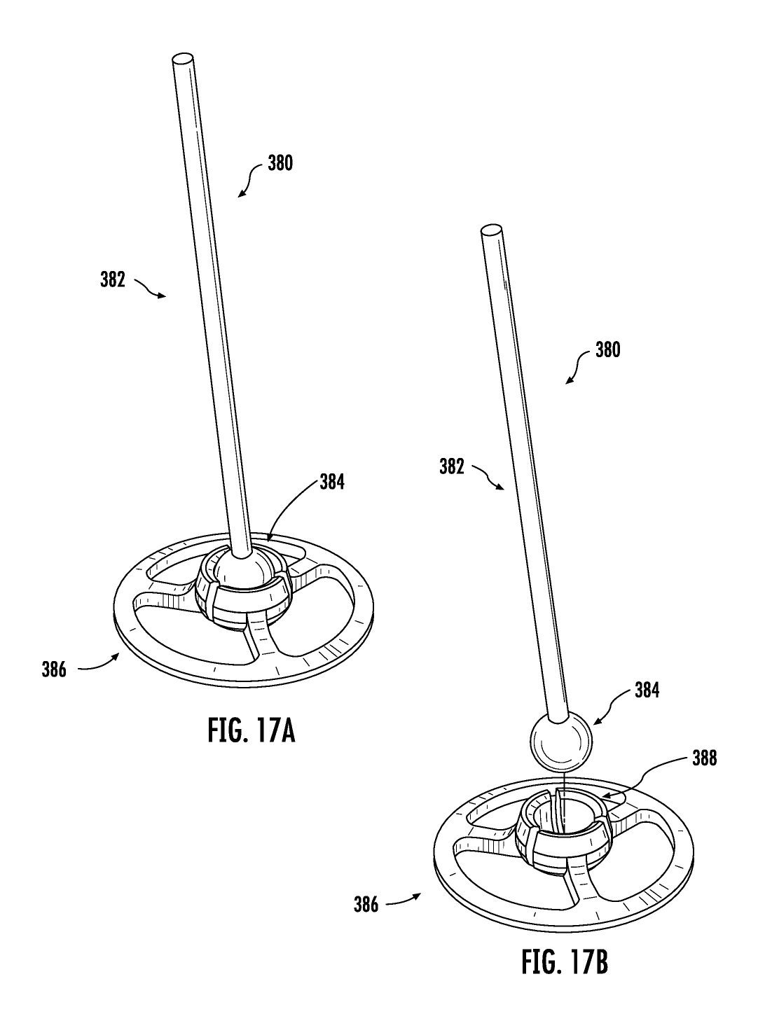

FIGS. 17A, 17B depict a tip 380 with a one piece base assembly 386 and securing portion, according to some embodiments described herein. As illustrated, the tip includes a pin 382, a pivotal connector 384, and the one piece base assembly 386. As discussed above, the one piece base assembly 386 may include a substrate, a conductive layer, conductive paste and/or other components. In this embodiment, the one piece base assembly 386 includes an integrated securing mechanism 388, which is configured as a flexible member and includes a base aperture receives and removably secures the pivotal connector 384 in a ball socket configuration. The integrated securing mechanism 388 may include a plurality of slits, which may allow for insertion of the pivotal connector 384.

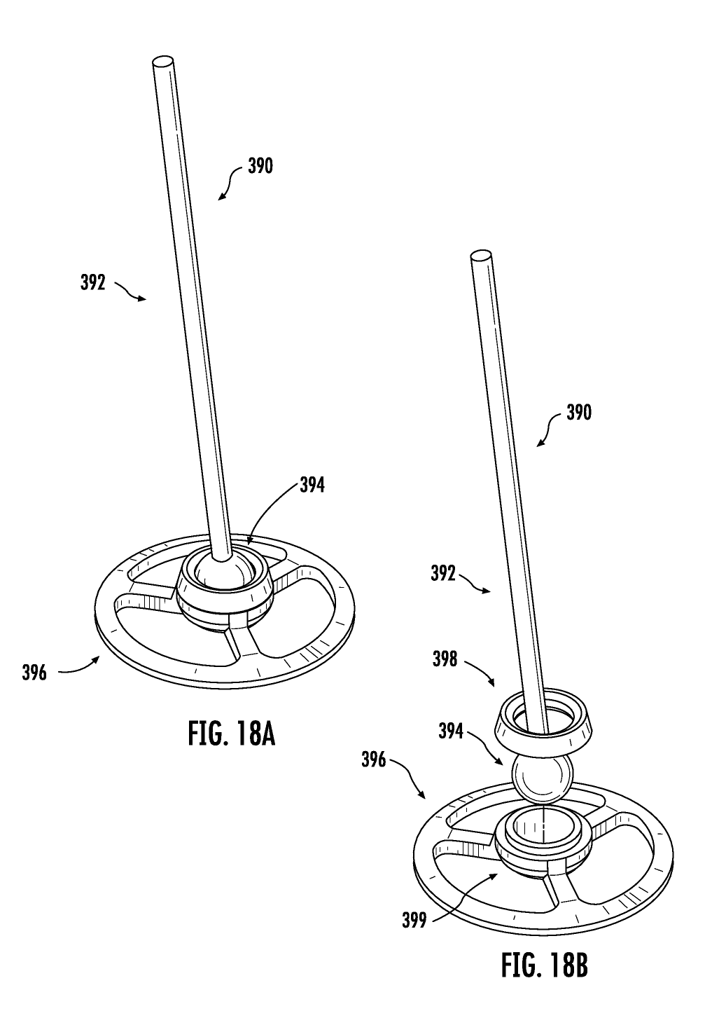

FIGS. 18A, 18B depict another tip 390 with a securing mechanism 398 or other removable cover, according to some embodiments described herein. As illustrated, the tip 390 includes a pin 392, a pivotal connector 394, and a base assembly 396. As discussed above, the base assembly 396 may include a substrate, a conductive layer, conductive paste and/or other components. The base assembly 396 may additionally include an integrated securing portion 399, which receives the pivotal connector 394. The securing mechanism 398 may be glued and/or screwed onto the integrated securing portion 399 for securing the pivotal connector 394. As with other embodiments described herein, the pivotal connector 394 may be rotated to provide greater efficiency in use.

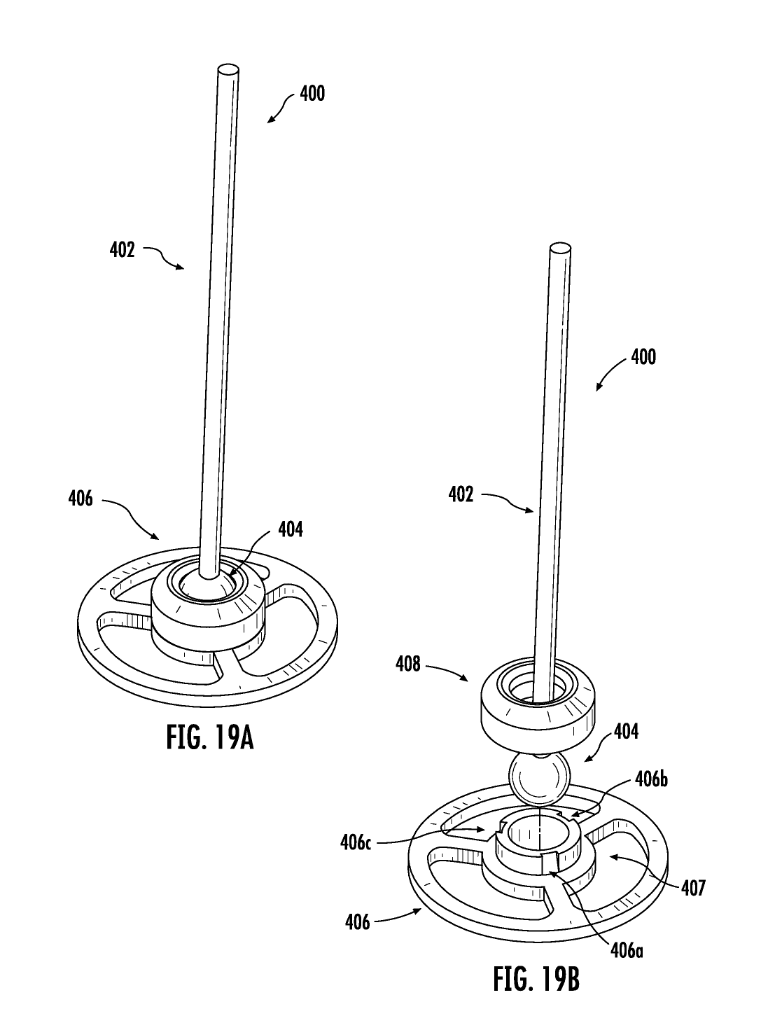

FIGS. 19A, 19B depict another tip 400 with a securing mechanism 408, according to some embodiments described herein. As illustrated, the tip 400 includes a pin 402, a pivotal connector 404, and a base assembly 406. As discussed above, the base assembly 406 may include a substrate, a conductive layer, conductive paste and/or other components. The base assembly 406 may additionally include a center portion 407, which includes a plurality of extension portions extending therefrom. The center portion 407 includes an area for receiving the pivotal connector 404. Also included in the center portion 407 is a plurality of notches 406a, 406b, 406c. The securing mechanism 408 may be configured for engaging with the notches 406a, 406b, 406c to secure the pivotal connector 404.

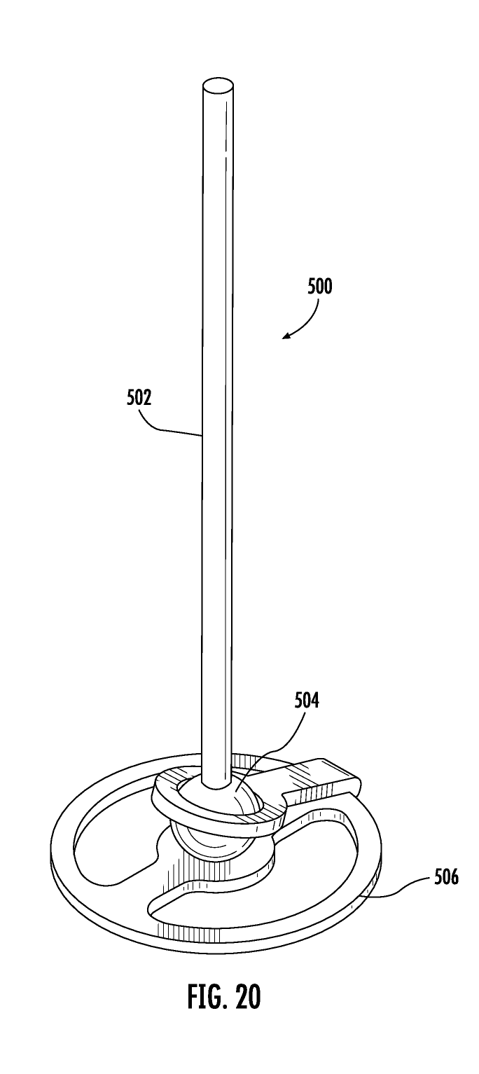

FIG. 20 depicts a tip 500 with a bi-spoke wheeled base assembly 506 and a hinged securing mechanism 504, according to embodiments described herein. As illustrated, the bi-spoke wheeled base assembly 506 may be substantially circular, oval, or other similar shape and may be coupled to the hinged securing mechanism 504. As discussed above, the bi-spoke wheeled base assembly 506 may include a substrate, a conductive layer, conductive paste and/or other components. The hinged securing mechanism 504 may be configured as a cover to prevent the pivotal connector portion of the pin 502 from disengaging with the bi-spoke wheeled base assembly 506. To this end, the hinged cover portion may include an aperture that is sized to contain the pivotal connector, while allowing the pin 502 to rotate when engaged.

Various additional advantages and modifications beyond those discussed herein will be apparent to one of ordinary skill in the art. Therefore, embodiments described herein lie in the claims hereinafter appended.

Therefor, at least the following is claimed:

1. An apparatus configured to be removably coupled to an instrument for interacting with a touch screen device, the apparatus comprising:
a pin that comprises a first end and a second end, wherein the first end removably attaches to the instrument; and
a base assembly that is coupled to the second end of the pin, wherein the base assembly comprises at least the following:
a substrate layer, wherein the substrate layer is substantially transparent in appearance; and
a conductive layer, wherein the conductive layer is substantially transparent in appearance and electrically interacts with conductive regions of the touch screen device and the substrate layer.

2. The apparatus of claim 1, wherein the pin further comprises a pivotal connector coupled to the second end and wherein the base assembly further comprises a base aperture for receiving the pivotal connector, wherein when the pivotal connector is received by the base aperture the pin is removably secured to the base assembly, such that the pivotal connector may rotate within the base aperture.

3. The apparatus of claim 2, wherein the base assembly further comprises a securing mechanism for securing the pivotal connector to the base assembly.

4. The apparatus of claim 3, wherein the securing mechanism includes at least one of the following: a removable cover, a flexible member, a plurality of securing pieces, and a hinged cover portion.

5. The apparatus of claim 2, further comprising a conductive paste applied to the base aperture to facilitate interaction with the conductive regions of the touch screen device.

6. The apparatus of claim 1, wherein the base assembly is configured as a spring.

7. The apparatus of claim 1, wherein the conductive layer comprises a conductive mesh, including at least one of the following: unpatterned transparent conductor (UTC) film and indium tin oxide (ITO) film.

8. A stylus configured to be removably coupled to an instrument for interacting with a touch screen device, the stylus comprising:
a writing instrument; and
a tip, wherein the writing instrument comprises a receiving mechanism for receiving the tip, wherein the tip comprises:
a pin that comprises a first end and a second end, wherein the first end removably attaches to the instrument; and
a base assembly that is coupled to the second end of the pin, wherein the base assembly comprises at least the following:
a substrate layer, wherein the substrate layer is substantially transparent in appearance; and
a conductive layer, wherein the conductive layer is substantially transparent in appearance and electrically interacts with conductive regions of the touch screen device and the substrate layer.

9. The stylus of claim 8, wherein the pin further comprises a pivotal connector coupled to the second end and wherein the base assembly further comprises a base aperture for receiving the pivotal connector, wherein when the pivotal connector is received by the base aperture, the pin is removably secured to the base assembly, such that the pivotal connector may rotate within the base aperture.

10. The stylus of claim 9, wherein the base assembly further comprises a securing mechanism for securing the pivotal connector to the base assembly.

11. The stylus of claim 10, wherein the securing mechanism includes at least one of the following: a removable cover, a flexible member, a plurality of securing pieces, and a hinged cover portion.

12. The stylus of claim 9, further comprising a conductive paste applied to the base aperture to facilitate interaction with the conductive regions of the touch screen device.

13. The stylus of claim 8, wherein the base assembly is configured as a spring.

14. The stylus of claim 8, wherein the conductive layer comprises a conductive mesh, including at least one of the following: unpatterned transparent conductor (UTC) film and indium tin oxide (ITO) film.

15. An apparatus configured to be removably coupled to an instrument for interacting with a touch screen device, the apparatus comprising:
a pin that comprises a first end, a second end, and a pivotal connector coupled to the second end, wherein the first end removably attaches to the instrument; and
a base assembly comprising a base aperture for receiving the pivotal connector, wherein the base assembly is coupled to the second end of the pin, wherein the base assembly comprises at least the following:
a substrate layer, wherein the substrate layer is substantially transparent in appearance; and
a conductive layer, wherein the conductive layer is substantially transparent in appearance and electrically interacts with conductive regions of the touch screen device and the substrate layer,
wherein when the pivotal connector is received by the base aperture, the pin is removably secured to the base assembly, such that the pivotal connector may rotate within the base aperture.

16. The apparatus of claim 15, wherein the base assembly further comprises a securing mechanism for securing the pivotal connector to the base assembly.

17. The apparatus of claim 16, wherein the securing mechanism includes at least one of the following: a removable cover, a flexible member, a plurality of securing pieces, and a hinged cover portion.

18. The apparatus of claim 15, further comprising a conductive paste applied to the base aperture to facilitate interaction with the conductive regions of the touch screen device.

19. The apparatus of claim 15, wherein the base assembly is configured as a spring.

20. The apparatus of claim 15, wherein the conductive layer comprises a conductive mesh, including at least one of the following: unpatterned transparent conductor (UTC) film and indium tin oxide (ITO) film.
